(19) United States
(12) Patent Application Publication
(10) Pub. No.: US 2019/0387515 A1
(43) Pub. Date: Dec. 19, 2019

(54) Post-Grant Beam Tracking

(71) Applicant: Google LLC, Mountain View, CA (US)

(72) Inventors: Erik Richard Stauffer, Sunnyvale, CA (US); Jibing Wang, Saratoga, CA (US)

(73) Assignee: Google LLC, Mountain View, CA (US)

(21) Appl. No.: 16/008,511

(22) Filed: Jun. 14, 2018

(51) Int. Cl. H04W 72/04; H04W 72/14

(52) U.S. Cl. CPC H04W 72/046; H04W 16/28; H04W 72/14

(57) ABSTRACT

The present disclosure describes techniques and systems for post-grant beam tracking. These techniques may include a user device receiving a pilot transmission between receiving an uplink grant and transmitting associated data. The pilot transmission may assist the user device in selecting a transmission configuration, such as selection of a beam or selection of transmitting antennas, for transmitting the associated data. Further, the user device may receive the pilot transmission, from a base station, over a beam tracking pilot channel of a wireless connection with the base station.

### BACKGROUND

The evolution of wireless communication to fifth generation (5G) standards and technologies provides higher data rates and greater capacity, with improved reliability and lower latency, which enhances mobile broadband services. 5G technologies enable new classes of services for vehicular networking, fixed wireless broadband, and the Internet of Things (IoT).

A unified air interface, which utilizes licensed, unlicensed, and shared license radio spectrum in multiple frequency bands is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband.

However, radio signals at higher frequencies can have higher susceptibility to fading, interference, and reflections. To counter these susceptibilities, base stations that provide wireless connections over higher frequencies may focus transmissions using beam forming techniques to extend a transmission range and reduce interference. Many beam configurations can be formed between a base station and a user device, but the user device may need to frequently reconfigure arrays of antennas to switch between beam configurations based on current and changing conditions in the radio environment around the user device.

### SUMMARY

This document describes techniques for, and systems that enable, post-grant beam tracking. Post-grant beam tracking includes a process of determining a beam to use for wireless communications. More particularly, these techniques may include a user device receiving a pilot transmission between receiving an uplink grant and transmitting data associated with the uplink grant. The user device may use the pilot transmission in selecting a transmission configuration, such as selection of a beam or selecting one or more antennas, for transmitting the associated data. Further, the user device may receive the pilot transmission over a beam tracking pilot channel of a wireless connection from a base station.

In some aspects, a user device receives, using one or more transceivers, an uplink grant for transmitting data over a wireless connection with a base station. The uplink grant identifies communication resources, within a frequency bandwidth, allocated for transmitting the data. The user device also receives a pilot transmission from the base station by using the transceivers. The pilot transmission is received over one or more resource elements that are located within at least a portion of the frequency bandwidth of the communication resources allocated for transmitting the data. Based on the pilot transmission, the user device determines a transmission configuration for transmitting the data over the wireless connection. The user device transmits the data to the base station over the wireless connection using the determined configuration.

In other aspects, a user device includes a processor, a hardware-based transceiver, and a computer-readable storage medium having instructions stored thereon. Responsive to execution of the instructions by the processor, the processor performs operations relating to post-grant beam tracking. The operations include receiving, using the hardware-based transceiver, an uplink grant identifying a frequency bandwidth of an uplink channel of a wireless connection with a base station. The uplink channel includes an allocation of resources for transmitting data to the base station. The operations also include receiving, from the base station and using the hardware-based transceiver, a pilot transmission over one or more communication resources. The one or more communication resources are located, in a frequency-domain, within the frequency bandwidth of the uplink channel. The operations further include determining, based on the reception of the pilot transmission, a transmission configuration for a transmission of the data over the uplink channel. The operations then include transmitting, to the base station and using the hardware-based transceiver, the data over the uplink channel, the transmission based on the determined transmission configuration.

In further aspects, a base station includes a processor, one or more hardware-based transceivers, and a computer-readable storage medium having instructions stored thereon. Responsive to execution of the instructions by the processor, the processor performs operations relating to post-grant beam tracking. The operations include transmitting, to a user device and using the one or more hardware-based transceivers, an uplink grant for a transmission of data over a wireless connection. The operations also include transmitting, to the user device and via the one or more hardware-based transceivers, a pilot transmission over a beam tracking pilot channel that includes one or more resource elements within at least a portion of the frequency bandwidth. The operations further include receiving, from the user device and via the one or more hardware-based transceivers, the transmission of the data. The transmission of the data is based on the transmission of the pilot transmission.

The details of one or more implementations are set forth in the accompanying drawings and the following description. Other features and advantages will be apparent from the description, drawings, and claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of post-grant beam tracking are described below. The use of the same reference numbers in different instances in the description and the figures indicates similar elements:

FIG. 1 illustrates an example operating environment in which post-grant beam tracking can be implemented.

FIG. 2 illustrates an example operating environment with multiple channels over which the user device and base station may communicate.

FIG. 3 illustrates an example operating environment in which the user device and base station may communicate in accordance with one or more aspects of post-grant beam tracking.

FIG. 4 illustrates an example operating environment in which the user device and multiple base stations may communicate in accordance with one or more aspects of post-grant beam tracking.

FIG. 5 illustrates example communication resources, in a frequency-time domain, over which the base station can transmit beam pilots to the user device.

FIG. 6 illustrates an example method performed by the user device for post-grant beam tracking.

FIG. 7 illustrates another example method performed by the user device for post-grant beam tracking.

FIG. 8 illustrates an example method performed by the base station for post-grant beam tracking.

### DETAILED DESCRIPTION

With advances in wireless communication technology, base stations are able to provide wireless connections with user devices using communication channels operating at higher radio frequencies, such as communication channels used by fifth generation new radio (5G NR) wireless networks. Transmissions over these higher-frequency communication channels can have higher susceptibility to fading, interference, and reflections based on changing conditions at the user device. Therefore, base stations that provide wireless connections using higher-frequency communication channels may use beamforming techniques to extend a range of the high-frequency transmissions. Beamforming techniques for wireless communication may use combinations of antenna arrays, or subarrays, of a user device or base station. Further, beamforming techniques may allow for multiple beam paths between an antenna of the base station and an antenna of a user device. With multiple choices of beams over which the user device and base station may communicate, selecting the beam that provides the best link quality enables better reception by a receiving base station or user device. However, a previously-effective beam may become ineffective if conditions change, for example if the user device moves out of the beam, an object obstructs the path of the beam, another radio transmission begins to interfere, or the user device experiences slow or fast fading conditions.

This document describes techniques and systems for post-grant beam tracking that may be used to improve a determination, by a user device, of a transmission configuration for transmitting data to a base station. The determined transmission configuration may include, for example, one or more of a direction to transmit radio signals, an antenna array from which to transmit, or a transmit power level. Improved determinations of transmission configurations can improve the reception and decoding of data, transmitted between the user device and the base station. For example, if an object, such as a hand of the user, obstructs an antenna or antenna array of the user device, the user device may determine to use another antenna or antenna array to avoid the obstruction. Further, although described as post-grant beam tracking, the pilot transmission may, in some implementations, be transmitted concurrently with the uplink grant or before the uplink grant.

In an illustrative implementation, a user device and a base station establish a wireless connection. The user device has data to transmit to the base station, so it submits an uplink request to the base station. After receiving the uplink request, the base station transmits an uplink grant that identifies communication resources allocated for the transmission of the data. The allocated communication resources occupy at least a portion of a frequency bandwidth and may be included in an uplink channel. After transmitting the uplink grant, the base station transmits a pilot transmission, including multiple pilots on multiple communication resources within the frequency bandwidth that includes the allocated communication resources. The user device receives and analyzes pilots of the pilot transmission to determine a transmission configuration for the transmission of the data. The determined transmission configuration may include a configuration of one or more antenna arrays or subarrays to use and a direction to transmit to the base station. The determined transmission configuration may further define an encoding for signals sent to each antenna. Using the determined transmission configuration, the user device transmits the data to the base station.

The following discussion describes an operating environment and techniques that may be employed in the operating environment. In the context of the present disclosure, reference is made to the operating environment by way of example only.

Operating Environment

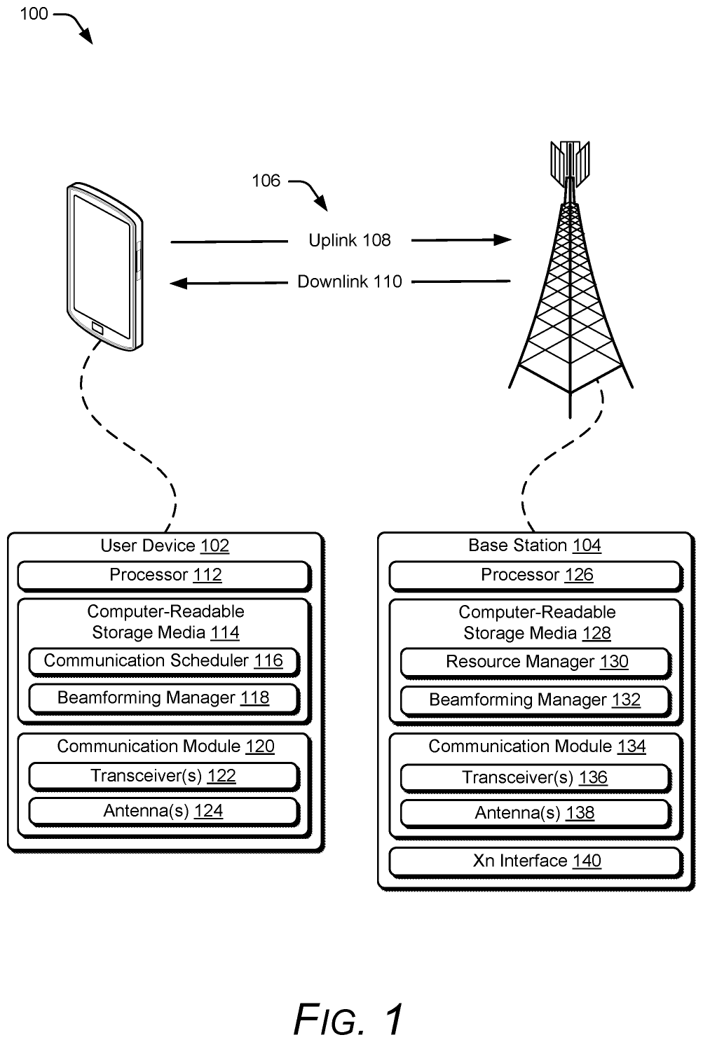

FIG. 1 illustrates an example operating environment 100 in which post-grant beam tracking can be implemented. In this example, the operating environment includes a user device 102 (or “user equipment” or “UE”) and a base station 104, which are respectively configured to communicate over a wireless connection 106 of a wireless network. Generally, the wireless connection 106 includes an uplink 108 by which the user device 102 transmits data to the base station 104 and a downlink 110 by which the base station 104 transmits other data to the user device 102. However, in some implementations, the wireless connection 106 may include only one of the uplink 108 or the downlink 110. Although shown or described with reference to a separate uplink 108 or downlink 110, communication between the user device 102 and the base station 104 may also be referenced as a wireless association, a frame exchange, a wireless link, or a communication link.

The wireless connection 106 may be implemented in accordance with any suitable protocol or standard, such as a Global System for Mobile Communications (GSM), Worldwide Interoperability for Microwave Access (WiMax), a High Speed Packet Access (HSPA), Evolved HSPA (HSPA+) protocol, a long-term evolution (LTE) protocol, an LTE Advanced protocol, a Fifth Generation (5G) New Radio (NR) protocol, or a future advanced protocol. The protocol may operate based on frequency division duplexing (FDD) or time division duplexing (TDD). The wireless connection 106 may operate over a high bandwidth, such as a bandwidth greater than 1 GHz. Further, the wireless connection 106 may be configured to allow for operation at frequencies above 3 GHz, as well as lower frequencies, such as those between 500 MHz and 3 GHz. More specifically, the wireless connection 106 may be configured to operate in a millimeter wave frequency range.

The user device 102 includes a processor 112, computer-readable storage media (CRM) 114 having a communication scheduler 116 and a beamforming manager 118, and a communication module 120. The user device 102 is illustrated as a smart phone, however the user device 102 may instead be implemented as any device with wireless communication capabilities, such as a mobile gaming console, a tablet, a laptop, an advanced driver assistance system (ADAS), a point-of-sale (POS) terminal, a health monitoring device, an unmanned aircraft, a camera, a media-streaming dongle, a wearable smart-device, an internet-of-things (IoT) device, a personal media device, a navigation device, a mobile-internet device (MID), a wireless hotspot, a femtocell, a smart vehicle, or a broadband router.

The processor 112 of the user device 102 can execute processor-executable instructions or code stored by the CRM 114 to cause the user device 102 to perform operations or implement various device functionalities. In this example, the CRM 114 also stores processor-executable code or instructions for implementing one or more of the communication scheduler 116 or the beamforming manager 118 of the user device 102.

A processor, such as the processor 112, can be implemented as an application processor (e.g., multicore processor) or a system-on-chip with other components of the user device 102 integrated therein. A CRM, such as the CRM 114, may include any suitable type of memory media or storage media, such as read-only memory (ROM), programmable ROM (PROM), random access memory (RAM), static RAM (SRAM), or Flash memory. In the context of this discussion, a CRM is implemented as hardware-based storage media, which does not include transitory signals or carrier waves. In some cases, a CRM stores one or more of firmware, an operating system, or applications of an associated device as instructions, code, or information. The instructions or code can be executed by an associated processor to implement various functionalities of the associated device, such as those related to network communication.

In some aspects, the communication scheduler 116 identifies data for transmitting to the base station 104. The communication scheduler 116 may identify an amount of data, a required latency for transmission of the data, or a type of the data for transmitting. Once the data is identified, the communication scheduler causes the user device to transmit, to the base station 104, a request for an uplink grant. After receiving an uplink grant from the base station 104, the communication scheduler 116 coordinates with the communication module 120 to transmit the data over communication resources identified in the uplink grant.

The beamforming manager 118 determines a transmission configuration for transmitting the data to the base station 104. For example, the beamforming manager 118 may determine a direction to transmit radio signals, an antenna array from which to transmit, an antenna subarray from which to transmit the data, or an uplink transmission power level. In determining the transmission configuration, the beamforming manager 118 may analyze one or more of a previous transmission, a reception of the uplink grant, or a pilot transmission. The pilot transmission may provide the most current data related to channel conditions between the base station 104 and the user device 102. Further, the pilot transmission may be transmitted over a longer time interval than the uplink grant. This longer time interval enables the user device 102 to evaluate the link quality of multiple antennas, antenna arrays, or subarrays.

The communication module 120 of the user device 102 includes one or more hardware-based transceiver(s) 122 and associated circuitry, software, or other components for wirelessly communicating with the base station 104. The communication module 120 also includes one or more of a radio frequency (RF) front end, an LTE transceiver, a 5G NR transceiver, or another transceiver of another radio access technology for communicating with the base station 104 or other base stations. The RF front end of the communication module 120 can couple or connect one or both of the LTE transceiver or the 5G NR transceiver to one or more antenna(s) 124 to facilitate various types of wireless communication. The antenna(s) 124 of the communication module 120 may include an array of multiple antennas that are configured similarly to or differently from each other. An array of multiple antennas may include one or more subarrays that include fewer than all of the multiple antennas of the array. The antenna(s) 124 and the RF front end can be tunable to one or more frequency bands defined by the 3GPP LTE or 5G NR communication standards and implemented by one or both of the LTE transceiver or the 5G NR transceiver. By way of example and not limitation, the antenna(s) 124 and the RF front end can be implemented for operation in sub-gigahertz bands, sub-6 GHZ bands, and/or above 6 GHz bands that are defined by the 3GPP LTE or 5G NR communication standards.

The communication module 120 may transmit, via a transmitter of the transceiver, data to the base station 104 via one or more radio frequency channels of the uplink 108, such as a physical random access channel (PRACH), a physical uplink control channel (PUCCH), or a physical uplink shared channel (PUSCH). The data transmitted to the base station 104 may include framed or packetized information, such as the indication that the search beam pilot meets the signal quality threshold, an uplink control information (UCI) communication, a radio resource control (RRC) message, a sounding reference signal (SRS), a PRACH communication, device status information, wireless connection status information, wireless connection control information, data requests, application data, or network access requests. The communication module 120 may also receive, via a receiver of the transceiver, other data from the base station 104 over one or more channels of the downlink 110, such as a physical downlink control channel (PDCCH), a physical downlink shared channel (PDSCH), a downlink beam tracking pilot (DL_BTP) channel, or a physical hybrid automatic repeat request (HARQ) indicator channel (PHICH). The other data may include one or more of application data, downlink pilots, primary or secondary synchronization signals (PSSs or SSSs), a master information block (MIB), a system information block (SIB), a downlink control information (DCI) message, an RRC message, a downlink grant, an uplink grant, wireless connection configuration settings, network control information, or a communication mode selection.

In this example, the base station 104 is shown generally as a cellular base station of a wireless network. The base station 104 may be implemented to provide and manage a cell of a wireless network that includes multiple other base stations that each manage another respective cell of the wireless network. As such, the base station 104 may communicate with a network management entity or others of the multiple base stations to coordinate connectivity, cell-management, or handovers of user devices within or across the cells of the wireless network.

The base station 104 can be configured as any suitable type of base station or network management node, such as a GSM base station (e.g., a Base Transceiver Station, a BTS), a Node B transceiver station (e.g., for UMTS), an Evolved Universal Terrestrial Radio Access Network Node B (E-UTRAN Node B, evolved Node B, eNodeB, eNB, e.g., for LTE), or a Next Generation Node B (gNode B, or gNB, e.g., for 5G NR). As such, the base station 104 may control or configure parameters of the uplink 108 or the downlink 110 in accordance with one or more of the wireless standards or protocols described herein.

The base station 104 includes a processor 126, a computer-readable storage media (CRM) 128, and a communications module 134. The CRM 128 includes a resource manager 130 and a beamforming manager 132. In this example, the CRM 128 also stores processor-executable code or instructions for implementing the resource manager 130 and the beamforming manager 132 of the base station 104.

In some aspects, the resource manager 130 of the base station 104 is implemented to perform various functions associated with allocating physical access, such as communication resources (e.g., resource blocks), for the air interface of the base station 104. The air interface of the base station 104, may be partitioned or divided into various units (e.g., frames, subframes, or slots) of one or more of bandwidth, time, symbols, or spatial layers. For example, within a framework of a 5G NR protocol, the resource manager 130 can allocate bandwidth and time intervals of access in resource blocks, each of which may be allocated in whole, or in part, to one or more channels for communicating with the user device 102. As discussed above, the channels may include one or more of a PRACH, a PUCCH, a PUSCH, a PDCCH, a PDSCH, a PHICH, or a DL_BTP channel The resource blocks may include multiple subcarriers that each span a portion of a frequency domain of the resource blocks. The subcarriers may be further divided into resource elements, or orthogonal frequency-division multiplexing (OFDM) symbols, that each span a portion of a time domain of the subcarriers. Consequently, a resource block includes multiple OFDM symbols that can be grouped into subcarriers with other OFDM symbols having a common frequency bandwidth.

In some aspects, the beamforming manager 132 assists the user device 102 in determining a transmission configuration for transmitting over the uplink 108. This may include transmitting a pilot transmission to the user device 102 after transmitting an uplink grant, but before the uplink is scheduled by the uplink grant. The pilot transmission may be transmitted over a duration of time that is sufficient for the user device 102 to evaluate link qualities provided by multiple antennas or antenna arrays. Additionally or alternatively, the pilot transmission may be transmitted such that the user device 102 can determine a beam direction for the uplink transmission. The beamforming manager 132 may also determine transmission configurations for the base station 104 to transmit data to user devices, such as the user device 102. The transmission configurations may be different for each user device or groups of user devices based on a beamwidth of a beam provided by the base station 104 or a distance to each user device 102.

The communication module 134 of the base station 104 includes one or more hardware-based transceiver(s) 136 and associated circuitry, software, or other components for wirelessly communicating with the user device 102. The one or more transceivers(s) 136 include one or more of a radio frequency (RF) front end, an LTE transceiver, a 5G NR transceiver, or another transceiver of another radio access technology for communicating with the user device 102, other user devices, or other base stations. The RF front end of the communication module 134 can couple or connect one or both of the LTE transceiver or the 5G NR transceiver to one or more antenna(s) 138 to facilitate various types of wireless communication. The antenna(s) 138 of the communication module 120 may include an array of multiple antennas that are configured similarly to or differently from each other. An array of multiple antennas may include one or more subarrays that include fewer than all of the multiple antennas of the array. The antenna(s) 138 and the RF front end can be tunable to one or more frequency bands defined by the 3GPP LTE or 5G NR communication standards and implemented by one or both of the LTE transceiver or the 5G NR transceiver. By way of example and not limitation, the antenna(s) 138 and the RF front end can be implemented for operation in sub-gigahertz bands, sub-6 GHZ bands, and/or above 6 GHz bands that are defined by the 3GPP LTE or 5G NR communication standards.

The communication module 134 may be configured to communicate over a frequency range of the wireless medium and over multiple spatial layers and beams. The base station 104 may transmit any suitable data or information to the user device 102 through the downlink 110, such as a pilot transmission, a schedule of pilots of a pilot transmission, an uplink grant, application data, wireless connection-status information, or wireless connection-control information. The base station 104 may receive any suitable data or information from the user device 102 through the uplink 108, such as application data, an uplink request, uplink data, or a control message.

In some implementations of the base station 104, an Xn interface provides user-plane and control-plane data communication between a serving cell base station and a neighbor base station. For example, the base station 104 may be the serving cell base station that provides user-plane and control-plane data to another base station. The user-plane and control-plane data may include instructions for coordinating a distributed antenna array or a virtual antenna array to form a coordinated beam for communicating with the user device 102.

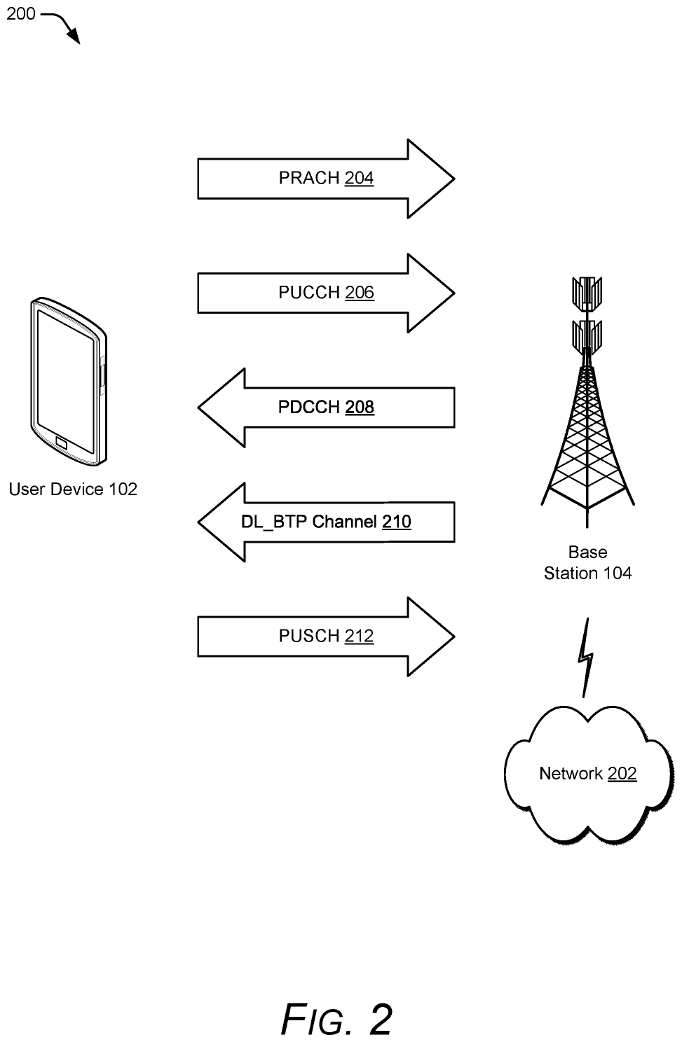

FIG. 2 illustrates an example operating environment 200 in which a user device and a base station may communicate in accordance with one or more aspects of post-grant beam tracking. The operating environment includes respective instances of the user device 102 and the base station 104, which provides a wireless network with which the user device 102 and other user devices may wirelessly connect. Through the wireless network, the base station 104 may enable or provide access to other networks or resources, such as a network 202 (e.g., the Internet) connected via a backhaul link (e.g., fiber network). Additionally or alternately, the operating environment 200 may include other base stations or a mobility manager such as a mobility management entity (MME) or an access and mobility management function (AMF), to provide and manage an area wide wireless network, such as a 5G NR network and associated data services.

The user device 102 and the base station 104 may communicate through any suitable type or combination of channels, message exchanges, or network management procedures. In this example, the wireless connection 106 includes one or more channels such as a PRACH 204, a PUCCH 206, a PDCCH 208, a DL_BTP channel 210, and a PUSCH 212.

The user device 102 can transmit a request for an uplink or downlink grant via the PRACH 204. The user device 102 may also use the PRACH 204 to request that the base station 104 establish the wireless connection 106 with the user device 102. Generally, the PRACH 204 is a low-bandwidth channel for carrying small amounts of data.

The PUCCH 206 may be used to transmit, to the base station 104, one or more of scheduling requests for uplink transmission, HARQ acknowledge/not acknowledge (ACK/NACK), channel quality indicators (CQI), multiple-input multiple-output (MIMO) feedback (e.g., a rank indicator (RI) or a precoding matrix indicator (PMI)), or keying for PUCCH modulation (e.g., binary phase-shift keying (BPSK) or quadrature phase-shift keying (QPSK)). In the context of post-grant beam tracking techniques, the user device 102 may use the PRACH or the PUCCH 206 to request an uplink grant from the base station 104.

The PDCCH 208 can be used by the base station 104 to communicate an uplink grant, downlink control information (DCI) messages, or radio resource control (RRC) messages to the user device 102. In some aspects, the DCI messages include identification of resource elements to be used for communication of data to the user device 102. In the context of post-grant beam tracking techniques, the base station 104 transmits the uplink grant over the PDCCH 208. The base station 104 may also transmit an RRC message to semi-statically (semi-persistently) configure a pilot transmission, such as configuring the pilot for a time period longer than one subframe. For example, an RRC message may set a configuration for a pilot transmission that is used until another control message changes the configuration. Alternatively, the base station 104 may transmit a DCI message to dynamically configure the pilot transmission. The configuration of the pilot transmission may include a timing interval relative to one or both of the transmission of the uplink grant or the scheduled uplink identified in the uplink grant. Additionally or alternatively, the configuration of the pilot transmission may include one or more of locations (e.g., one or more OFDM symbols in a time-domain or one or more frequency tones in a frequency-domain) of resources over which pilots will be transmitted, a density of pilots in the pilot transmission, or a duration of the pilot transmission.

The base station 104 can use the DL_BTP channel 210 to transmit a pilot transmission to the user device 102. The DL_BTP channel 210 may include allocated resources that are located, in a time domain, between those of the PDCCH 208 and those of the PUSCH 212. The user device 102 can use the pilot transmission transmitted over the allocated resources of the DL_BPT to determine a transmission configuration for transmitting data to the base station 104.

The user device 102 may send data or other information to the base station 104 via the PUSCH 212. For example, the user device 102 may transmit application data over the PUSCH 212 after receiving a pilot transmission over the DL_BTP channel. The PUSCH may operate using a modulation and coding scheme (MCS) with a relatively high data rate, compared with the PUCCH 206 or the PDCCH 208, for data transmissions. This relatively high data rate may require a relatively high signal-to-noise ratio (SNR) to properly receive and demodulate transmissions over the PUSCH 212.

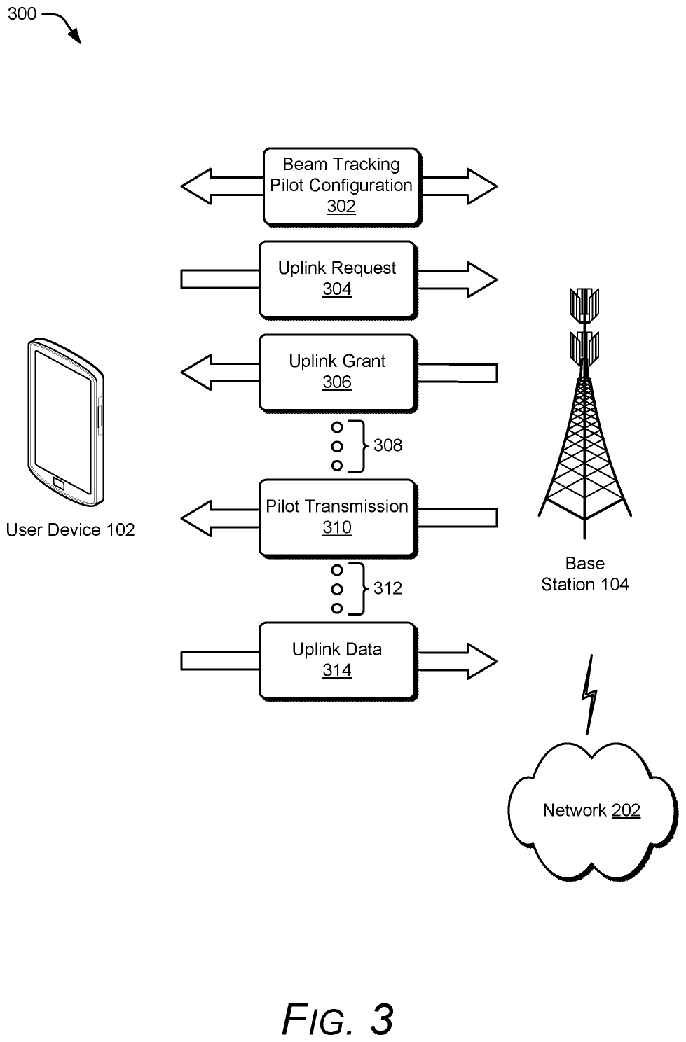

FIG. 3 illustrates an example operating environment 300 in which a user device and a base station may communicate in accordance with one or more aspects of post-grant beam tracking. The operating environment 300 includes respective instances of the user device 102, the base station 104, and the network 202.

In this example, the user device 102 and the base station 104 agree upon a beam tracking pilot configuration 302. This may be accomplished by the base station 104 transmitting the beam tracking pilot configuration 302 to the user device 102. The user device may then transmit an acknowledgement of the beam tracking pilot configuration 302 transmitted by the base station 104. Alternatively, the user device 102 may propose the beam tracking pilot configuration 302 in a transmission to the base station 104. This agreement may be made via one or more RRC messages, DCI messages, SIB communications, or MIB communications.

The user device 102 transmits an uplink request 304 to the base station 104. Based on the uplink request 304, the base station 104 determines communication resources to allocate for a transmission of data by the user device 102. After determining the allocation, the base station 104 transmits an uplink grant 306 to the user device 102 to identify the communication resources allocated for the transmission of the data. The uplink grant 306 may also identify a configuration of a pilot transmission 310.

After an interval of time 308, the base station 104 transmits the pilot transmission 310 to the user device 102. As discussed, the interval of time 308 may be directly configured semi-statically in an RRC message from the base station 104 or dynamically in a DCI message from the base station 104. Alternatively, the interval of time 308 may be indirectly configured based on a configuration of an interval of time 312 between reception of the pilot transmission 310 and the transmission of the data. In other implementations, the pilot transmission 310 may be received before the uplink grant 306.

The pilot transmission 310 may be transmitted over a frequency bandwidth that includes the communication resources allocated by the base station 104 for the transmission of the data. The pilot transmission 310 may include multiple pilots transmitted over multiple resources. The pilot transmission 310 may be configured with a duration or a density of pilots based on an expected need of the user device 102. For example, the base station 104 may determine, based on a low signal quality of a previous communication or a location of the user device 102 being far from the base station 104, that the user device 102 has an expected need of a long-duration pilot transmission with a high density of pilots. Before this determination, the base station 104 may receive location data from the user device 102. Additionally, the pilot transmission 310 may include multiple pilots transmitted over two or more MIMO layers (spatial layers) corresponding to two or more MIMO layers of the allocated resources for the transmission of the data. For example, the two or more MIMO layers over which the multiple pilots are transmitted may be a same set of MIMO layers of the allocated resources for the transmission of the data. Further, the pilot transmission 310 may be encoded, or scrambled, using a user device-specific sequence.

The user device 102 receives the pilot transmission 310 to assist in determining a transmission configuration for the transmission of the data. For example, the user device 102 may determine a beam direction with the best available link quality over which to transmit the data. Additionally or alternatively, the user device 102 determines which antenna array, or antenna sub-array, to use for the transmission. This may be particularly beneficial if an object is blocking an antenna array of the user device 102 but is not blocking another antenna array of the user device 102. The user device 102 then configures the communication module 120 and transmits the data, as uplink data 314, to the base station 104. The interval of time 312 may be configured to be relatively short, compared to the interval of time 308, to reduce a delay between a determination of a transmission configuration and actual transmission of the uplink data 314. However, the interval of time 312 may be long enough to allow a transceiver of the user device 102 to switch between a receiving configuration and a transmitting configuration. By way of example and not limitation, the switching may require 10-100 microseconds.

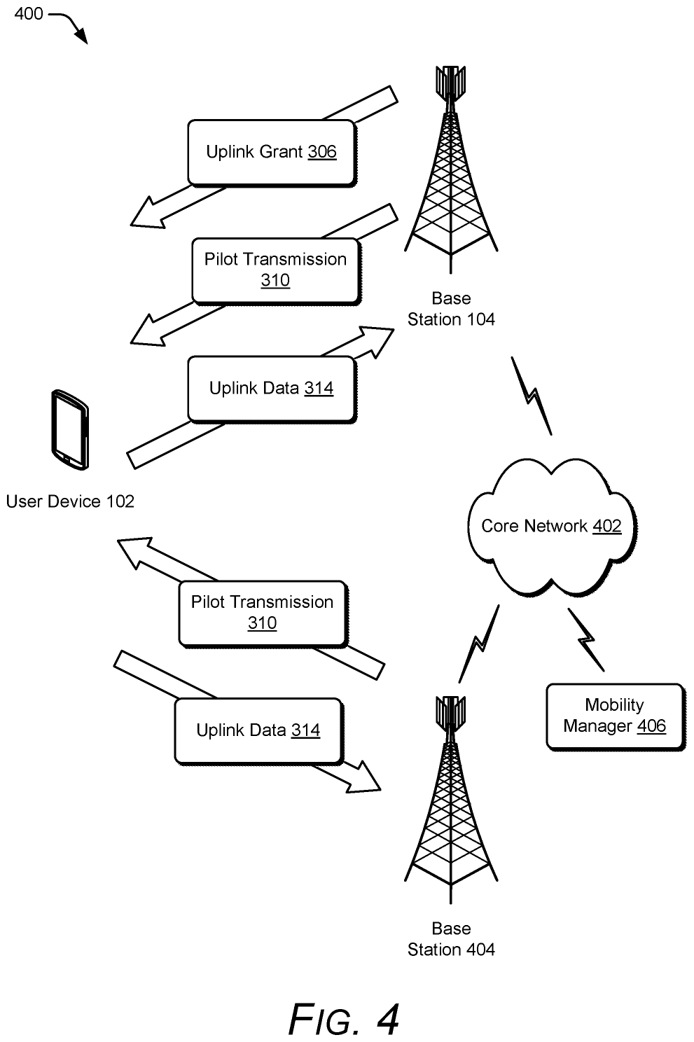

FIG. 4 illustrates an example operating environment 400 in which a user device and a base station may communicate in accordance with one or more aspects of post-grant beam tracking. The operating environment 400 includes respective instances of the user device 102, the base station 104, and the core network 402 of the wireless network. The operating environment 400 also includes another base station 404 and a mobility manager 406, such as an MME or an AMF.

The base stations 104 and 404 and the mobility manager 406 may coordinate to provide a wireless connection over a coordinated beam. In this example, the base stations 104 and 404 act as a distributed antenna array or a virtual antenna array to form the coordinated beam. One of the base stations 104 or 404 may act as a master base station that provides instructions to the user device 102 and the other base station for coordinated wireless communication. These instructions may be provided to the other base station directly, such as via an Xn interface, or indirectly over the network 402. In other implementations, the mobility manager 406 may provide instructions to both of the base stations 104 and 404 for coordinated wireless communication.

In the illustrated implementation, the base station 104 provides an uplink grant 306 to the user device 102. The uplink grant 306 may be transmitted by only one of the base stations 104 and 404 because the uplink grant 306 may be transmitted with an MCS that provides a relatively low data rate and therefore may be successfully received via a radio link with a relatively low SNR. However, in some implementations, the base station 404 may also transmit the uplink grant 306 on a coordinated beam to improve an SNR of the uplink grant 306 as observed by the user device 102. The base stations 104 and 404 coordinate a transmission of the pilot transmission 310 to the user device 102. Based on the coordinated pilot transmission 310, the user device 102 determines a transmission configuration for transmitting uplink data 314 to the base stations 104 and 404. Although illustrated as the uplink data 314 being transmitted directly to each of the base stations 104 and 404, the user device 102 may transmit the uplink data 314 on a single beam such that the one of the base stations 104 and 404 receives the uplink data 314 from a single transmission by the user device 102.

In other implementations, the base station 104 communicates with the user device 102 via a wireless connection that is independent from a wireless connection between the user device 102 and the base station 404. In some of these implementations, the wireless connection with the base station 104 operates using a radio access technology that is different from a radio access technology of the wireless connection with the base station 404, such as using an LTE supplemental uplink with the base station 104. The base station 104 may provide the uplink grant 306 for the wireless connection with the base station 404. When this is the case, the pilot transmission 310 may be transmitted from the base station 404, but not the base station 104, so that the user device 102 can determine a transmission configuration for transmitting the uplink data 314 to the base station 404 and not to the base station 104.

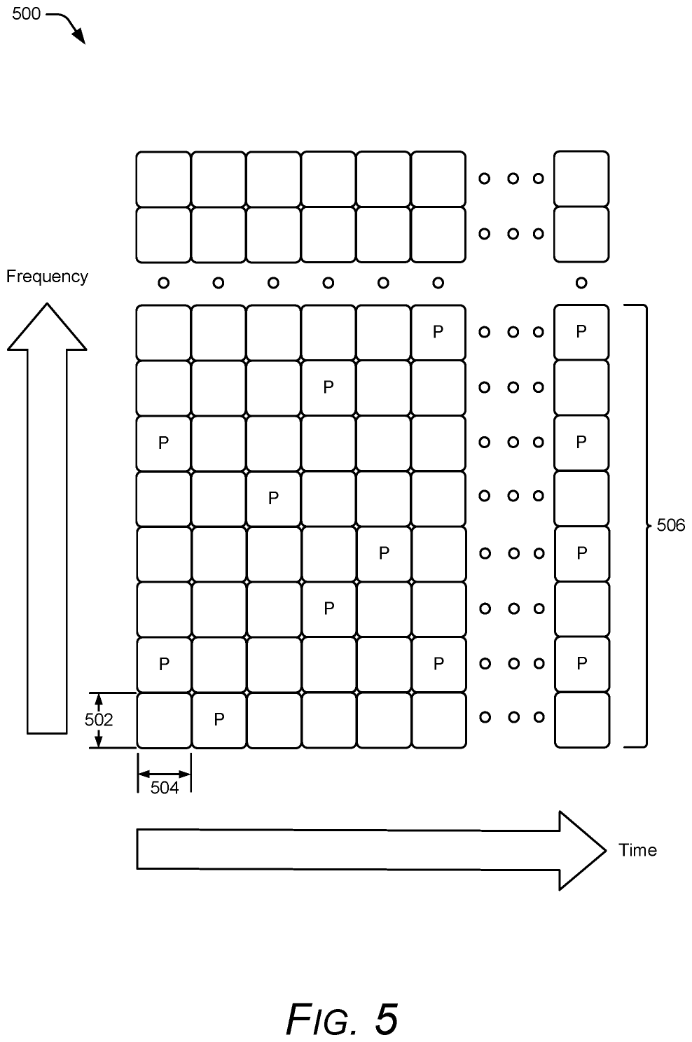

FIG. 5 illustrates example communication resources 500, in a frequency-time domain, over which the base station 104 can transmit a pilot transmission to the user device 102. Each of the communication resources 500 span a frequency bandwidth 502 and a time duration 504. The communication resources, shown as boxes, may be resource blocks, groups of resource blocks, resource elements, groups of resource elements that are a subset of a resource block, or other denominations of communication resources. A frequency bandwidth 506 includes communication resources allocated by the base station 104 to an uplink channel for transmitting data, during a later transmission time interval, from the user device 102 to the base station 104. Several of the communication resources within the frequency bandwidth 506 are labeled with “P” to indicate that the communication resources are scheduled for transmitting one or more pilots. The communication resources labeled with “P” may include multiple pilots.

As illustrated, the pilots can be transmitted as the pilot transmission 310 over communication resources within the frequency bandwidth 506 that is allocated for the uplink channel, such as the PUSCH 212. This allows the user device 102 to determine a signal quality of the pilots at a frequency that will be used to transmit the uplink data 314. This determination can assist the user device 102 in determining a transmission configuration for transmitting the uplink data 314.

The pilots may be transmitted throughout portions of the frequency bandwidth 506, all of the communication resources of the frequency bandwidth 506, or only a single communication resource of the frequency bandwidth 506. The pilot transmission 310 may span a duration of time, or quantity of OFDM symbols, that allows the user device 102 to test various antenna arrays or antenna subarrays for SNR. By way of example and not limitation, the pilots may span a duration of time between 0.3 and 1 millisecond to allow the user device to switch between the various antenna arrays or antenna subarrays for receiving the pilots. In some implementations, the duration of the pilot transmission 310 is longer than a duration of a transmission of the uplink grant 306. After the duration of the pilot transmission 310, the user device 102 may determine which of the antenna arrays or antenna subarrays received a portion of the pilot transmission with an SNR that exceeds a threshold for successfully transmitting the uplink data 314. The user device 102 may further determine which of the antenna arrays or antenna subarrays received a portion of the pilot transmission with a highest SNR. For example the user device 102 may determine which of the antenna arrays or antenna subarrays received a portion of the pilot transmission with a highest average SNR over multiple resources. Alternatively, the user device 102 may determine which of the antenna arrays or antenna subarrays received a portion of the pilot transmission with a highest SNR over any single resource.

Techniques for Post-Grant Beam Tracking

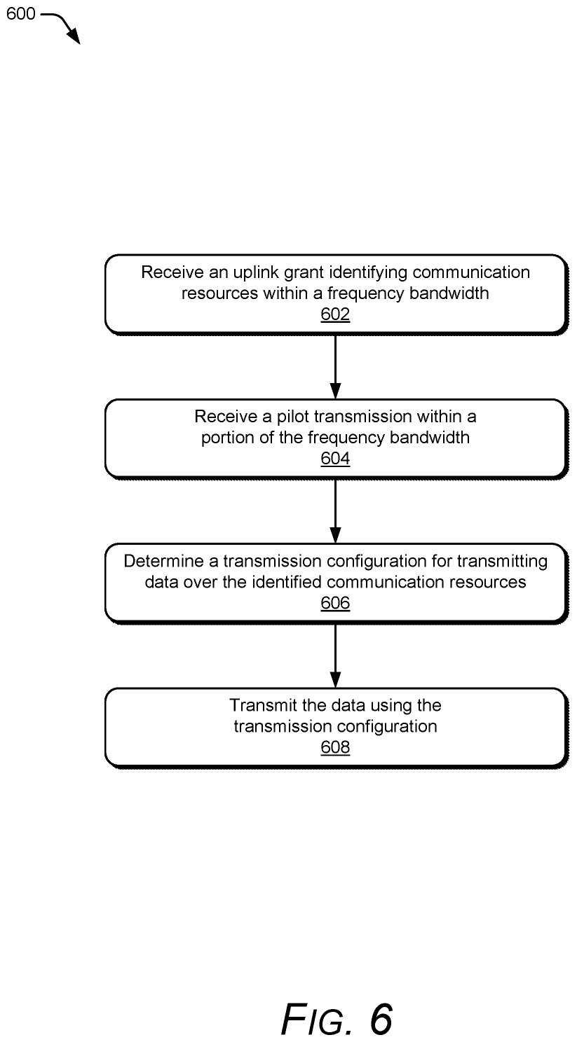

FIGS. 6-8 depict methods for implementing post-grant beam tracking. These methods are shown as sets of blocks that specify operations performed but are not necessarily limited to the order or combinations shown for performing the operations by the respective blocks. For example, operations of different methods may be combined, in any order, to implement alternate methods without departing from the concepts described herein. In portions of the following discussion, the techniques may be described in reference to FIGS. 1-5, reference to which is made for example only. Generally, any of the components, modules, methods, and operations described herein can be implemented using software, firmware, hardware (e.g., fixed logic circuitry), manual processing, or any combination thereof. The techniques are not limited to performance by one entity or multiple entities operating on one device, or those described in these figures.

FIG. 6 illustrates an example method 600 performed by a user device for implementing post-grant beam tracking. The method 600 includes operations that may be performed by a communication scheduler, such as the communication scheduler 116, a beamforming manager, such as the beamforming manager 118, and a communication module, such as the communication module 120. In some aspects, operations of the method 600 enable a user device to select an uplink transmission configuration with the best available link quality by receiving a pilot transmission before transmitting uplink data.

At operation 602, the user device receives an uplink grant for identifying communication resources within a frequency bandwidth. The uplink grant identifies communication resources, within the frequency bandwidth, allocated for transmitting. For example, the user device 102 receives, using one or more transceivers 122, the uplink grant 306 for transmitting the uplink data 314 over the wireless connection 106 with the base station 104. For example, the uplink grant 306 identifies communication resources within the frequency bandwidth 506.

At operation 604, the user device receives a pilot transmission within a portion of the frequency bandwidth. For example, the user device 102 receives, from the base station 104 and using the one or more transceivers 122, the pilot transmission 310 over one or more resource elements within at least a portion of the frequency bandwidth 506. In some implementations, the user device 102 receives a portion of the pilot transmission at a first antenna array and receives another portion of the pilot transmission at a second antenna array. The portion and the other portion may be mutually exclusive or may overlap. The user device 102 may further compare a first signal quality of the first portion of the pilot transmission received at the first antenna array and second signal quality of the second portion of the pilot transmission received at the second antenna array. In the comparison of the first signal quality and the second signal quality, the user device 102 may compare an average signal quality at one or more of the resource elements of each portion. Alternatively, the user device 102 may compare a highest signal quality of any single resource element of each portion.

At operation 606, the user device determines a transmission configuration for transmitting data over the identified communication resources. For example, the user device 102 determines, based on the pilot transmission 310, a transmission configuration of the communication module 120 for transmitting the uplink data 314 over the wireless connection 106.

At operation 608, the user device transmits the data using the transmission configuration. For example, the user device 102 transmits the uplink data 314, using the one or more transceivers 122 and based on the transmission configuration, to the base station 104 via the wireless connection 106.

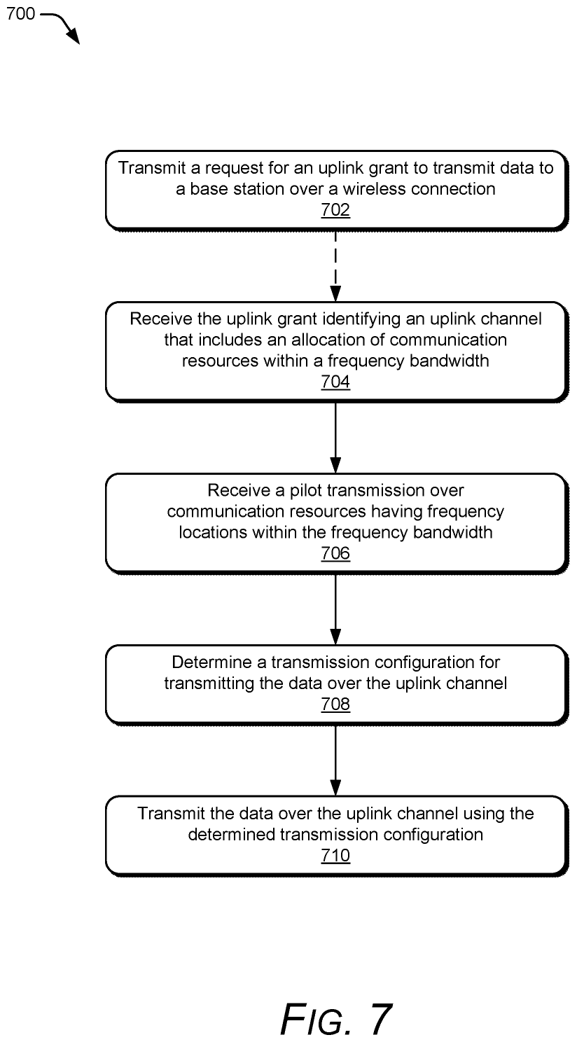

FIG. 7 illustrates an example method 700 performed by a user device for implementing post-grant beam tracking. The method 700 includes operations that may be performed by a communication scheduler, such as the communication scheduler 116, a beamforming manager, such as the beamforming manager 118, and a communication module, such as the communication module 120. In some aspects, operations of the method 700 allows a user device to determine an uplink transmission configuration with the best available link quality for transmitting uplink data.

At optional operation 702, the user device transmits a request for an uplink grant to transmit data to a base station in a wireless network. For example, the user device 102 transmits the uplink request 304 to the base station 104 over the wireless connection 106 of a wireless network.

At operation 704, the user device receives the uplink grant identifying an uplink channel that includes an allocation of communication resources, within a frequency bandwidth, for transmitting the data. For example, the user device 102 receives the uplink grant 306 from the base station 104 and using one of the transceivers 122 of the communication module 120. The uplink grant 306 may identify the frequency bandwidth 506 of the PUSCH 212.

At operation 706, the user device receives a pilot transmission over communication resources having frequency locations within the frequency bandwidth. For example, the user device 102 receives, from the base station 104 and using one of the transceivers 122, the pilot transmission 310 over one or more of the communication resources 500. The communication resources have frequency locations within the frequency bandwidth 506 of the uplink channel.

At operation 708, the user device determines a transmission configuration for transmitting the data over the uplink channel. For example, the user device 102 determines, based on the reception of the pilot transmission, a transmission configuration for the communication module 120 for transmission of the uplink data 314 over the uplink channel.

At operation 710, the user device transmits the data over the uplink channel using the determined transmission configuration. For example the user device 102 transmits the uplink data 314 over the PUSCH 212 using the determined transmission configuration for the communication module 120.

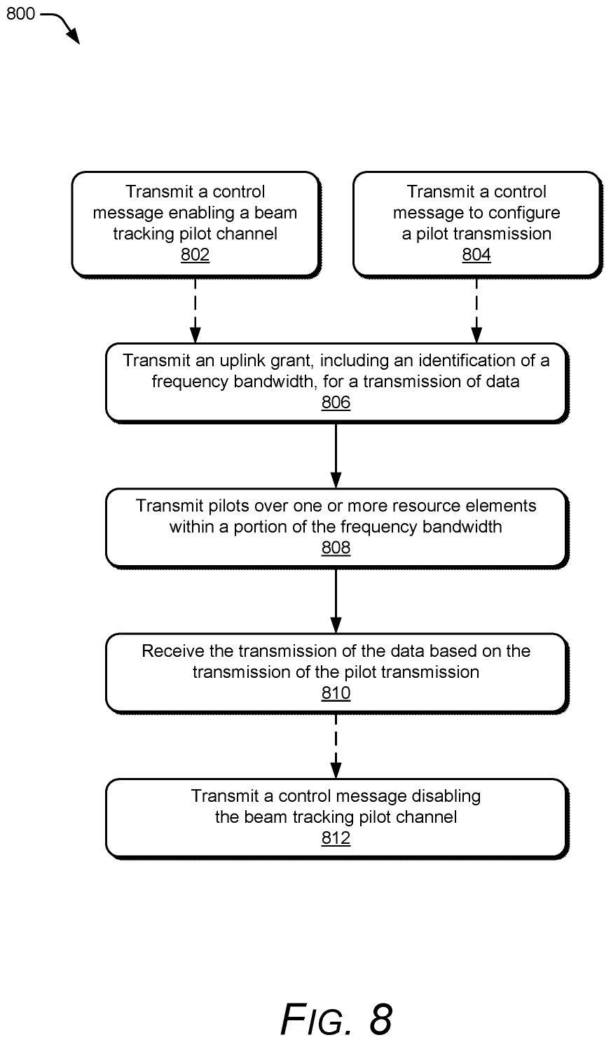

FIG. 8 illustrates an example method 800 performed by a base station for implementing post-grant beam tracking. The method 800 includes operations that may be performed by a resource manager, such as the resource manager 130, a beamforming manager, such as the beamforming manager 132, and a communication module, such as the communication module 134. In some aspects, operations of the method 800 provide pilot signals to a user device to enable the user device to select an uplink transmission configuration with the best available link quality.

At optional operation 802, the base station transmits a control message enabling a beam tracking pilot channel. For example, the base station 104 transmits the beam tracking pilot configuration 302 to the user device 102 to enable the DL_BTP channel 210. The base station 104 may transmit the control message as a DCI message or an RRC message.

At optional operation 804, the base station transmits a control message to configure a pilot transmission. For example, the base station 104 may transmit the beam tracking pilot configuration 302 to the user device 102 to configure the pilot transmission 310. The beam tracking pilot configuration 302 may provide instructions of a location or duration of the pilot transmission 310. Additionally or alternatively, the beam tracking pilot configuration 302 may configure the interval of time 308 between the reception of the uplink grant 306 and the reception of the pilot transmission 310. Further, the beam tracking pilot configuration 302 may configure the interval of time 312 between the transmission of the pilot transmission 310 and the transmission of the uplink data 314.

At operation 806, the base station transmits an uplink grant, including an identification of a frequency bandwidth, for a transmission of data. For example, the base station 104 transmits the uplink grant 306 to the user device 102 using one or more of the transceivers 136 of the communication module 134. The uplink grant 306 includes an identification of the frequency bandwidth 506 of communication resources 500 allocated for the transmission of the uplink data 314.

At operation 808, the base station transmits pilots over one or more resource elements within a portion of the frequency bandwidth. For example, the base station 104 transmits the pilot transmission 310 to the user device 102 and using one or more transceivers 136 of the communication module 134. The pilot transmission 310 includes pilots transmitted over one or more resource elements within at least a portion of the frequency bandwidth 506.

At operation 810, the base station receives the data based on the transmission of the pilots. For example, the base station receives the uplink data 314 from the user device 102 and using one or more of the transceivers 136 of the communication module 134.

At operation 812, the base station 104 transmits a control message disabling the beam tracking pilot channel. For example, the base station 104 transmits, to the user device 102, the beam tracking pilot configuration 302 to disable the DL_BTP channel 210. The base station 104 may transmit the control message as a DCI message or an RRC message. The base station 104 may determine to disable the DL_BTP channel 210 based on consistently successful receptions of the uplink transmissions as a way to reduce overhead of the wireless connection 106, to reduce power consumption by the user device 102, or to reduce heat generation by the user device 102.

Although techniques using, and apparatuses for implementing, post-grant beam tracking have been described in language specific to features and/or methods, it is to be understood that the subject of the appended claims is not necessarily limited to the specific features or methods described. Rather, the specific features and methods are disclosed as example ways in which post-grant beam tracking can be implemented.

1. A method for determining a transmission configuration of a user equipment (UE), the method comprising:
receiving, by the UE, an uplink grant for transmitting data using a wireless connection with a base station, the uplink grant identifying communication resources, within a frequency bandwidth, allocated for the transmitting of the data;
receiving, by the UE, a beam tracking pilot transmission using one or more resource elements within at least a portion of the frequency bandwidth of the communication resources allocated for the transmitting of the data;
based on the receiving the beam tracking pilot transmission, determining, by the UE, a beam-formed transmission configuration for transmitting the data using the wireless connection; and
transmitting, by the UE and based on the determined, beam-formed transmission configuration, the data to the base station using the wireless connection.

2. The method as recited in claim 1, wherein the determining the beam-formed transmission configuration includes selecting, by the UE, one or more antenna arrays for the transmitting of the data.

3. The method as recited in claim 1, wherein the determining the beam-formed transmission configuration includes determining, by the UE, a beam direction for the transmitting of the data.

4. The method as recited in claim 1, wherein the receiving the beam tracking pilot transmission comprises:
receiving a first portion of the beam tracking pilot transmission at a first antenna array of the UE and receiving a second portion of the beam tracking pilot transmission at a second antenna array of the UE.

5. The method as recited in claim 4, wherein the determining the beam-formed transmission configuration includes:
comparing a first signal quality of the first portion of the beam tracking pilot transmission received at the first antenna array and a second signal quality of the second portion of the beam tracking pilot transmission received at the second antenna array.

6. (canceled)

7. The method as recited in claim 1, wherein the UE receives the beam tracking pilot transmission using two or more multiple-input multiple-output (MIMO) layers, the multiple MIMO layers including MIMO layers of the uplink grant for the transmitting of the data.

8. The method as recited in claim 1, wherein the UE receives the uplink grant using another wireless connection with another base station.

9. A user equipment (UE) comprising:
a processor;
one or more hardware-based transmitters;
one or more hardware-based receivers; and
a computer-readable storage medium comprising instructions executable by the processor to configure the processor to:
receive, using the one or more hardware-based receivers, an uplink grant identifying a frequency bandwidth of an uplink channel of a wireless connection with a base station, the uplink channel including an allocation of communication resources for transmitting data to the base station;
receive, from the base station and using the one or more hardware-based receivers, a beam tracking pilot transmission using one or more communication resources, the one or more communication resources having frequency locations within the frequency bandwidth of the uplink channel;
determine, based on the reception of the beam tracking pilot transmission, a beam-formed transmission configuration of the UE for a transmission of the data using the uplink channel; and
transmit the data, to the base station and using the one or more hardware-based transmitters, using the uplink channel, the transmission based on the determined, beam-formed transmission configuration.

10. The user equipment as recited in claim 9, wherein the uplink grant identifies the one or more communication resources with which the UE receives the beam tracking pilot transmission.

11. The user equipment as recited in claim 9, wherein the instructions are executable by the processor to configure the processor to receive a control message to semi-statically configure a timing interval between receiving the uplink grant and receiving the beam tracking pilot transmission.

12. The user equipment as recited in claim 9, wherein the instructions are executable by the processor to configure the processor to receive, prior to the reception of the beam tracking pilot transmission, a control message to dynamically configure a timing interval between the reception of the uplink grant and the reception of the beam tracking pilot transmission.

13. The user equipment as recited in claim 9, wherein the instructions are executable by the processor to configure the one or more hardware-based transmitters, prior to the transmission of the data using the uplink channel, based on the determined, beam-formed transmission configuration.

14. A base station comprising:
a processor;
one or more hardware-based transmitters;
one or more hardware-based receivers; and
a computer-readable storage medium comprising instructions executable by the processor to configure the processor to:
transmit, to a user equipment (UE) and using the one or more hardware-based transmitters, an uplink grant for a transmission of data using a wireless connection, the uplink grant including an identification of a frequency bandwidth of communication resources allocated for the transmission of the data;
transmit, to the UE and using the one or more hardware-based transmitters, a beam tracking pilot transmission using a beam tracking pilot channel comprising one or more resource elements within at least a portion of the frequency bandwidth of communication resources, the transmission being effective to cause the UE to determine a beam-formed transmission configuration; and
receive, from the UE and using the one or more hardware-based receivers, the transmission of the data based on the transmission of the beam tracking pilot transmission.

15. The base station as recited in claim 14, wherein the instructions are executable by the processor to transmit, prior to the transmission of the beam tracking pilot transmission, a control message directing the UE to use the beam tracking pilot channel.

16. The base station as recited in claim 15, wherein the instructions are executable by the processor to transmit, after the transmission of the beam tracking pilot transmission, a control message directing the UE to discontinue using the beam tracking pilot channel.

17. The base station as recited in claim 15, wherein the instructions are executable by the processor to transmit, prior to the transmission of the beam tracking pilot transmission, a control message to configure a timing interval between receiving the beam tracking pilot transmission and the transmission of the data.

18. The base station as recited in claim 14, wherein the transmission of the beam tracking pilot transmission includes a transmission of beam tracking pilots using two or more multiple-input multiple-output (MIMO) layers of the wireless connection.

19. The base station as recited in claim 14, wherein the transmission of the beam tracking pilot transmission includes a transmission of beam tracking pilots that are scrambled with a UE-specific sequence.

20. (canceled)

21. (canceled)

22. The method as recited in claim 1, wherein the user equipment receives the uplink grant from a first base station, and wherein the user equipment receives the beam tracking pilot transmission from a second base station.

23. The method as recited in claim 1, wherein the user equipment receives the uplink grant from a first base station, and wherein the user equipment receives the beam tracking pilot transmission as a coordinated transmission from the first base station and a second base station.
